(19) United States
(12) Patent Application Publication
(10) Pub. No.: US 2010/0017244 A1
(43) Pub. Date: Jan. 21, 2010

(54) METHOD FOR ORGANIZING PROCESSES

(75) Inventors: Debanjan Saha, Mohegan Lake, NY (US); Ramendra K. Sahoo, Mohegan Lake, NY (US); Anees A. Shaikh, Yorktown Heights, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/174,130

(22) Filed: Jul. 16, 2008

(51) Int. Cl. G06Q 10/00

(52) U.S. Cl. 705/8; 705/7

(57) ABSTRACT

Techniques for generating a target process are provided. The techniques include identifying at least one of one or more steps and one or more artifacts within a target process and one or more other processes, pre-fetching the at least one of one or more atomic steps, one or more decision steps and splits and one or more merges to be used in the target process from the one or more other processes, and associating the at least one of one or more atomic steps, one or more decision steps and splits and one or more merges to be used in the target process at one or more decision points to generate the target process.

### FIELD OF THE INVENTION

The present invention generally relates to information technology, and, more particularly, to process organization.

### BACKGROUND OF THE INVENTION

Information technology (IT) service procedures are typically captured as enterprise processes. Each enterprise process can have several tasks and sub-processes. There can also be several documents, charts, tools and role players are associated with the tasks. IT services as enterprise processes are not necessarily optimized to accommodate the constantly changing enterprise needs to new types of customers and their requirements. Similarly, emergence of new enterprise demands and fast-changing technology impose time and resource crunches to meet market demands. As such, enterprise processes advantageously need to be competitive and optimized to provide a return on investment (ROI) within a short span of time with minimal resource utilization.

Existing enterprise process organization approaches include numerous inefficiencies. For example, existing enterprise processes (termed as best practices) are certainly not “the best” representation of the processes with inadequate information available for a wide variety of processes. Also, several similar processes are termed as different processes due to targeted customer needs, thus leading to each process representing a customized process assembly line.

Static processes (with a combination of series of tasks) make the process enrichment leading to process optimization and standardization of the process quite complex and labor intensive. Static organization of processes with inadequate knowledge representation leads to difficulties in locating and duplicating tasks with different names with a wide variety of inputs, outputs and associations with other tasks.

In existing approaches, there are no specific warehouses of tasks or processes to be used as a library of processes. Existing process lists are built based on repeated usage of a certain order of enterprise transformations. Thus, the processes or tasks are either duplicated or optimized in a silo addressing specific customer needs. Processes or tasks rarely use nomenclature and/or process organizational conventions to uniquely represent the ownership of an individual or groups of tasks or sub processes. A process is a continuous vector of operations carried out while touching various intra- and inter-organizations. As such, a change in process structure introduces confusion to many account insights as well as payment plans.

### SUMMARY OF THE INVENTION

Principles of the present invention provide techniques for organizing processes. An exemplary method (which may be computer-implemented) for generating a target process, according to one aspect of the invention, can include steps of identifying at least one of one or more steps and one or more artifacts within a target process and one or more other processes, pre-fetching the at least one of one or more atomic steps, one or more decision steps and splits and one or more merges to be used in the target process from the one or more other processes, and associating the at least one of one or more atomic steps, one or more decision steps and splits and one or more merges to be used in the target process at one or more decision points to generate the target process.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a target process, according to an embodiment of the present invention:

FIG. 2 is a diagram illustrating a process with intricate steps and decisions not associated with a target process, according to an embodiment of the present invention;

FIG. 3 is a flow diagram illustrating techniques for pre-fetching, cataloging, warehousing, associating and dissociating a process, according to an embodiment of the present invention;

FIG. 4 is a diagram illustrating finding the atomic steps, decision steps, splits and merges within a target process, according to an embodiment of the present invention;

FIG. 5 is a diagram illustrating identifying steps from a secondary processing affecting the steps in a target process, according to an embodiment of the present invention;

FIG. 6 is a diagram illustrating a target process with input steps from other processes and places within the target process requiring such inputs, according to an embodiment of the present invention;

FIG. 7 is a diagram illustrating a new target process with pre-fetched, imported data, artifacts and information along with changed associations and dissociations, according to an embodiment of the present invention;

FIG. 8 is a flow diagram illustrating techniques for generating a target process, according to an embodiment of the present invention; and

FIG. 9 is a system diagram of an exemplary computer system on which at least one embodiment of the present invention can be implemented.

### DETAILED DESCRIPTION OF PREFERRED EMBODIMENTS

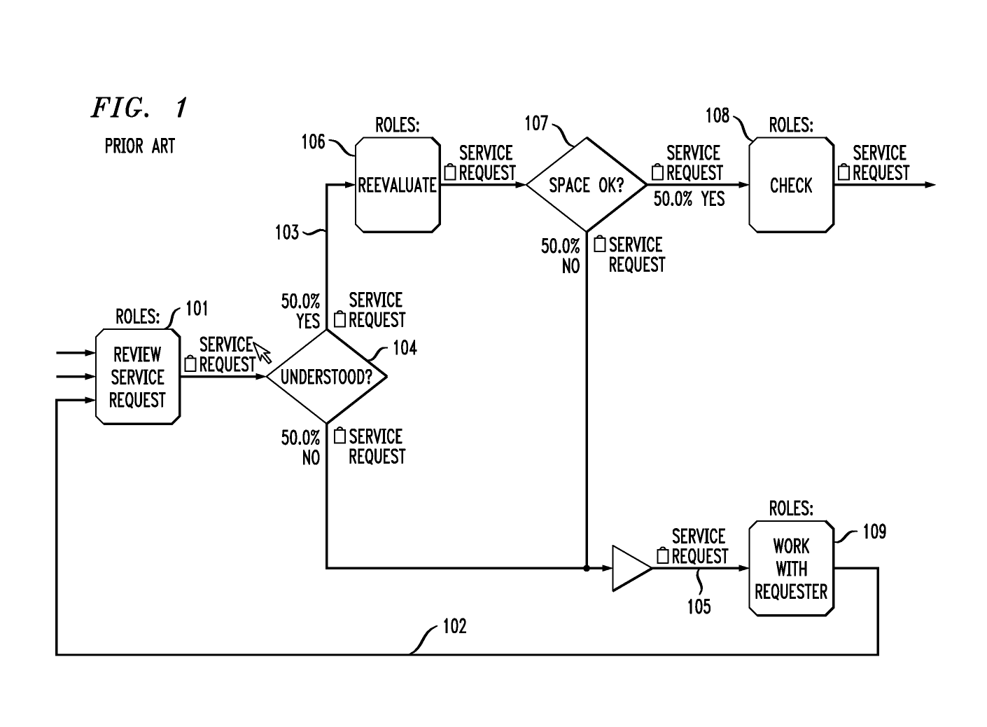

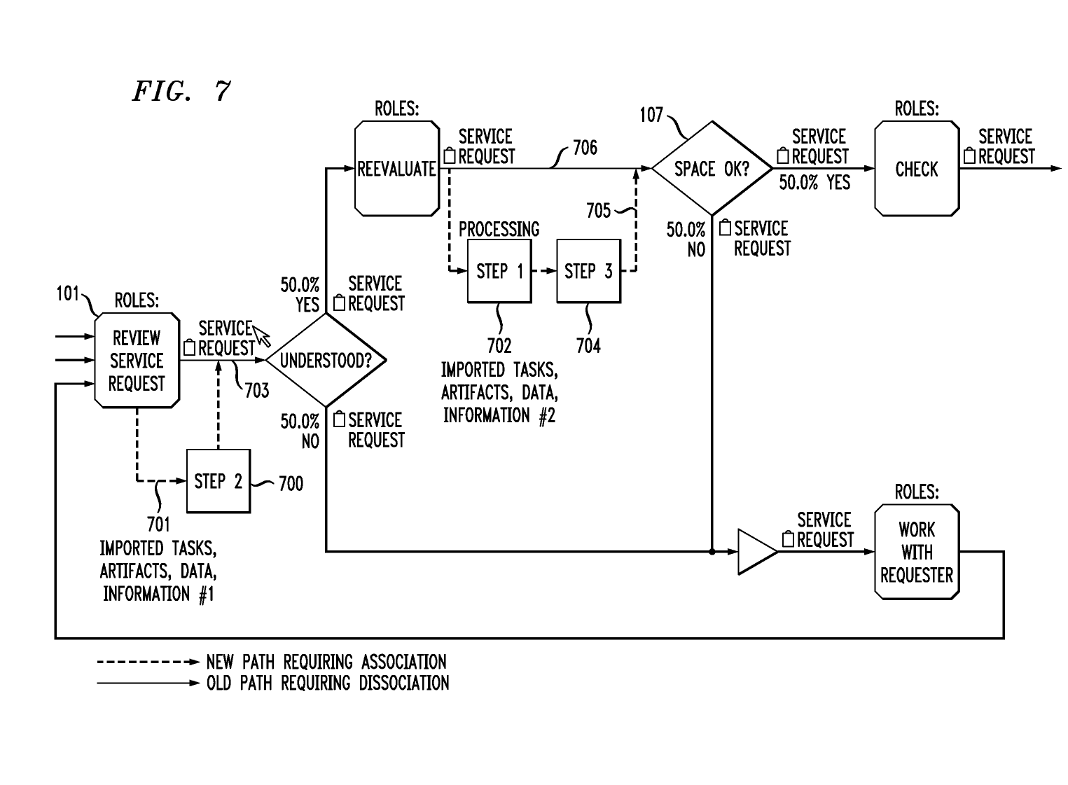

Principles of the present invention include an enterprise process organization, pre-fetching and cataloging techniques towards building customer-centric modular process chains. One or more embodiments of the invention include a mechanism to build a process warehouse with a defined relationship between various task level owners (see, for example, tasks 704 and 705 as depicted in FIG. 7). A basic element of the process organization, for example, would have a well-defined cost association between an old process and a new pre-fetched entity (see, for example, task 101 in FIG. 1).

One or more embodiments of the present invention also include a synchronized organization of processes and associated entities (both old and new), as well as ownership facilitating alerting and remedial measures at an atomic level by way of triggers and/or transaction protocols. Also, the techniques described herein include a process warehouse with plugged-in financial transactions at each self-contained task entity that can include, for example, approvals both from a financial and enterprise point of view hand-in-hand.

Additionally, one or more embodiments of the invention include a modular organization of indivisible tasks that can be pre-fetched for future operations. Pre-fetching and dynamic reordering and reorganization of the tasks eliminate backlogging and bottlenecks, while cross-breeding the skills for resources.

A relational warehouse putting together processes, associated annotations and financial as well as costs enables minimizing deficiencies. Adding an organization of processes (in addition to, for example, financial structure with cost centers and functional organization with divisions) links the process owner's performance with the functional and financial performance of the enterprise units as a whole.

Engaging a financial element and/or cost associated with a task (vis-a-vis, for example, a role relationship) mitigates accounting irregularities while meeting pertinent legal requirements in a structured manner with well-defined static and dynamic structure. Also, as described herein, a warehouse-based organization of processes would cut down and minimize cultivation of account or service line specific role relationships due to presence of a relation tree (which could be dynamically changing).

FIG. 1 is a diagram illustrating a flow diagram representing a target process, according to an embodiment of the present invention. Within FIG. 1, component 101 represents the process steps, while components 102 and 103 represent a relationship and/or association between task and/or process steps 101 and 109, and 104 and 106, respectively. Similarly, components 104 and 105 represent associated artifacts, information and/or data related to respective process steps. Also, component 106 represents a reevaluation step that is associated (service request) with the condition step 107, which includes determining whether there is adequate space. Additionally, step 108 depicts performing a check.

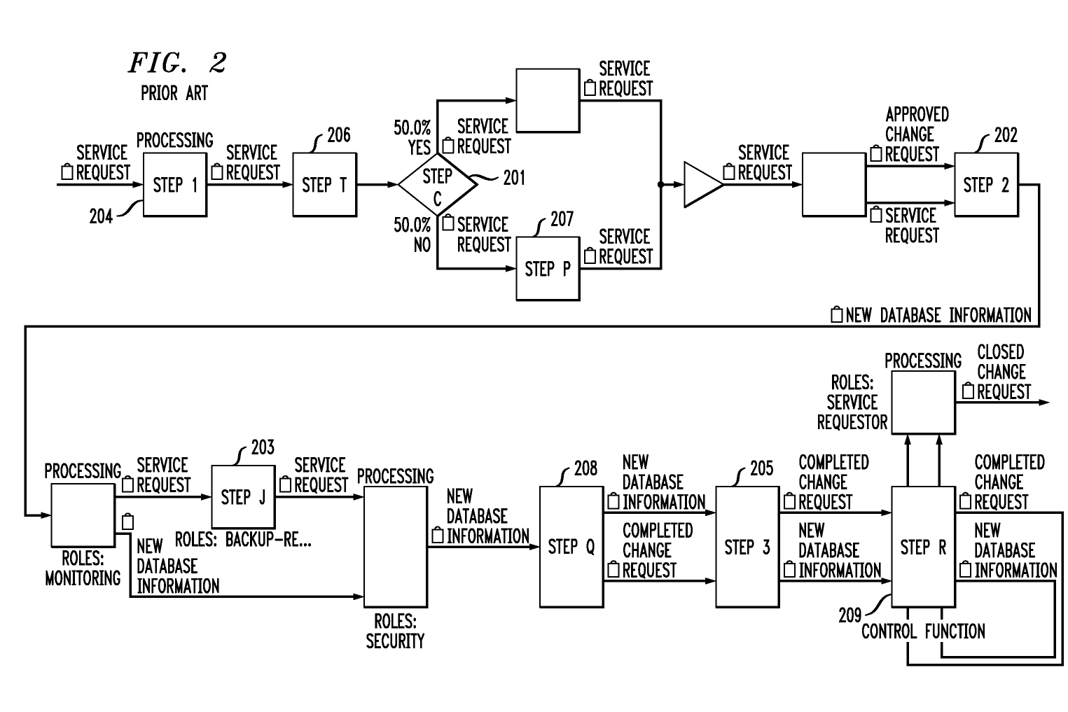

FIG. 2 is a diagram illustrating a flow diagram representing a process with intricate steps and decisions not associated with a target process, according to an embodiment of the present invention. FIG. 2 depicts an example of an existing approach corresponding to FIG. 1 which requires any related decisions (for example, finance, cost, penalty, etc.) taken independent of the skeletal process represented in FIG. 1. Within FIG. 2, components 201, 202, 203, 204 and 205 represent the process steps within another process. Out of these steps, steps 202, 204 and 205 are found to be associated with the target process in FIG. 1. Steps 201, 202, 203, 204 and 205 represent different groups of tasks having duplicate activities. Also, FIG. 2 depicts steps 206, 207, 208 and 209. As appropriate, other steps within FIG. 2 can have associations with target processes similar to the target process depicted in FIG. 1.

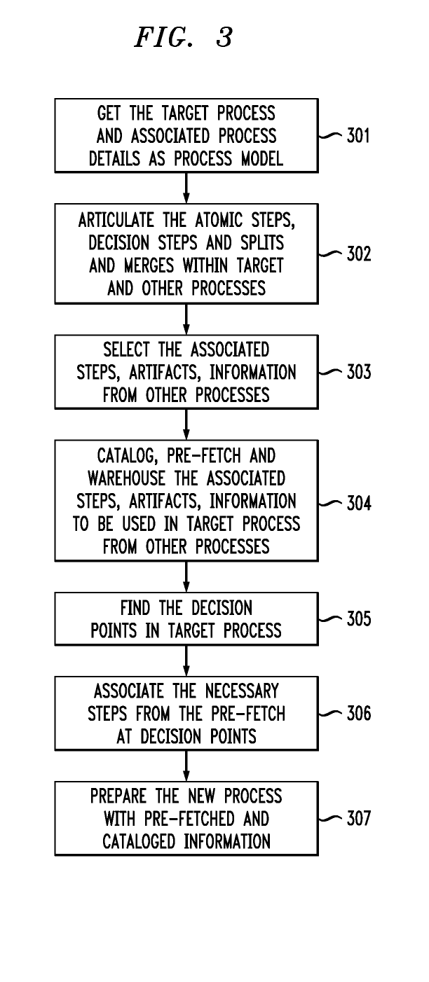

FIG. 3 is a flow diagram illustrating techniques for pre-fetching, cataloging warehousing, associating and dissociating a process, according to an embodiment of the present invention. Step 301 includes getting the target process and associated process details as a process model (for example, the preparation of a process model based on current best practices). Step 302 includes articulating the steps as atomic steps, decision steps and splits and merges within a target and other associated processes. Similarly, step 303 includes selecting any associated steps, artifacts and/or information from other processes related to a target process (such as depicted, for example, in FIG. 1).

Step 304 includes cataloging, pre-fetching and warehousing the associated steps, artifacts and/or information to be used in target process from other processes. A cataloging would index and represent each of these steps by way of unique indexing keys or composite keys so that these steps could be a part of a database. Moreover, pre-fetching would seek the information from a database prepared out of these entities with a defined size and at particular time so that it would minimize the transport of information from a database into target process. Additionally, step 305 includes finding decision points within a target process. Step 306 includes associating the decision steps within target process with the pre-fetched information and entities collected from other process. Also, step 307 includes preparing a final process diagram with associated new relationships along with removal of any redundant relationships from the target process.

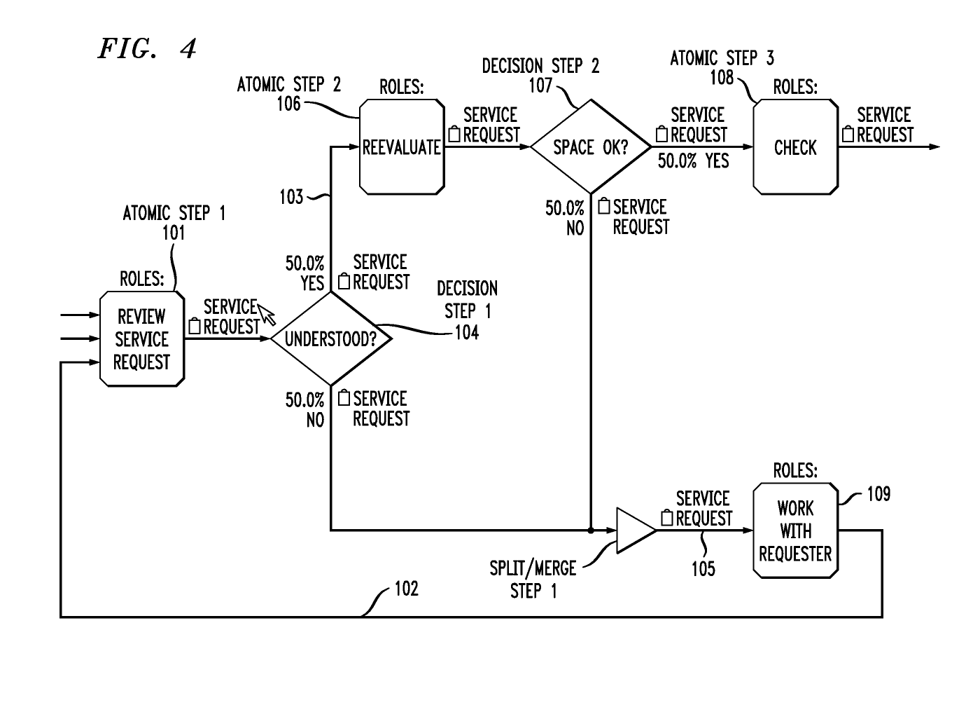

FIG. 4 is a diagram illustrating finding the atomic steps, decision steps, splits and merges within a target process, according to an embodiment of the present invention. In terms of examples of illustration, similar to the components identified in FIG. 1, components 101, 106, 108 and 109 represent atomic steps, while components 104 and 107 represent decision steps corresponding to an IT process (such as, for example, depicted in FIG. 1). Also, components 102 and 103 represent a relationship and/or association between task and/or process steps 101 and 109, and 104 and 106, respectively, while component 109 represents an illustration of a split and/or merge step (such as, for example, corresponding to FIG. 1).

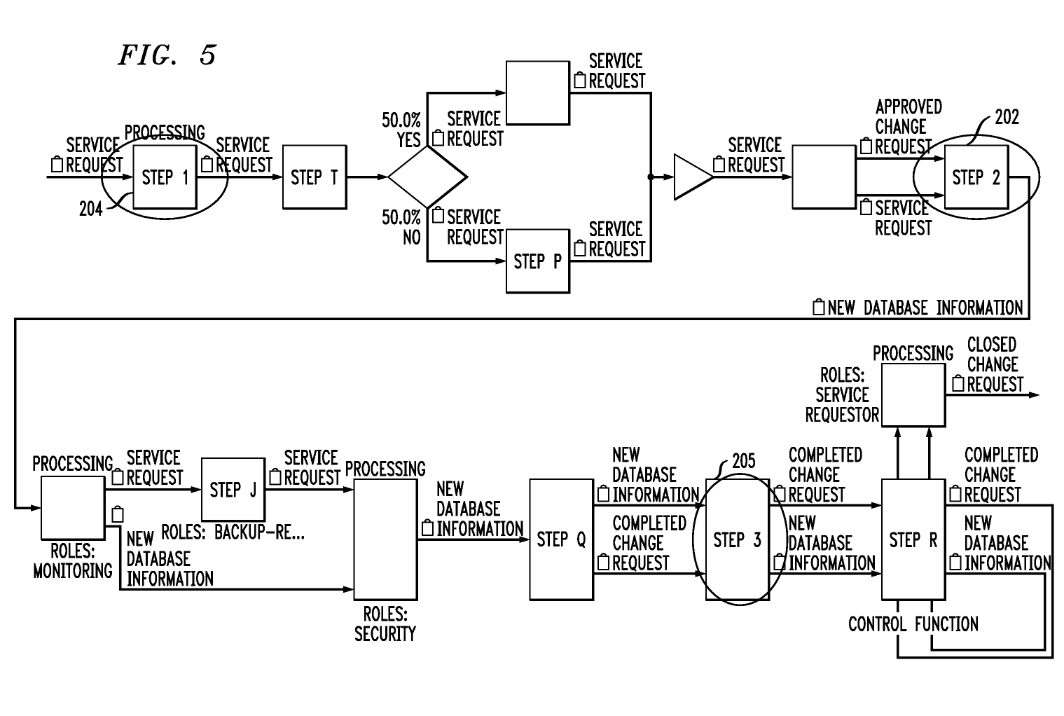

FIG. 5 is a diagram illustrating identifying steps from a secondary processing affecting the steps in a target process, according to an embodiment of the present invention. FIG. 5 depicts techniques so that the decision and artifacts (which could be anything from decision steps, information, related methodology or abstraction etc.) from a secondary process (similar to exemplary process depicted, for example, in FIG. 2) can be inserted into a target process (represented, for example, in FIG. 1). Within FIG. 5, similar to the components identified in FIG. 2, an illustration of process steps affecting a target process (such as, for example, within FIG. 1) can be represented by way of step 1 (that is, component 204), step 2 (that is, component 202) and step 3 (that is, component 205), respectively. An illustration of overlapping and/or similar tasks within a process is represented in FIG. 5, For example, tasks 204 and 205 are considered to be similar tasks with a target process (such as that depicted in FIG. 1) having dependency on these tasks. It is possible to isolate tasks within other processes (for example, FIG. 2) similar to tasks 202, 204 and 205 to determine their associations with other tasks either within a target process (for example, FIG. 1) or other similar target processes.

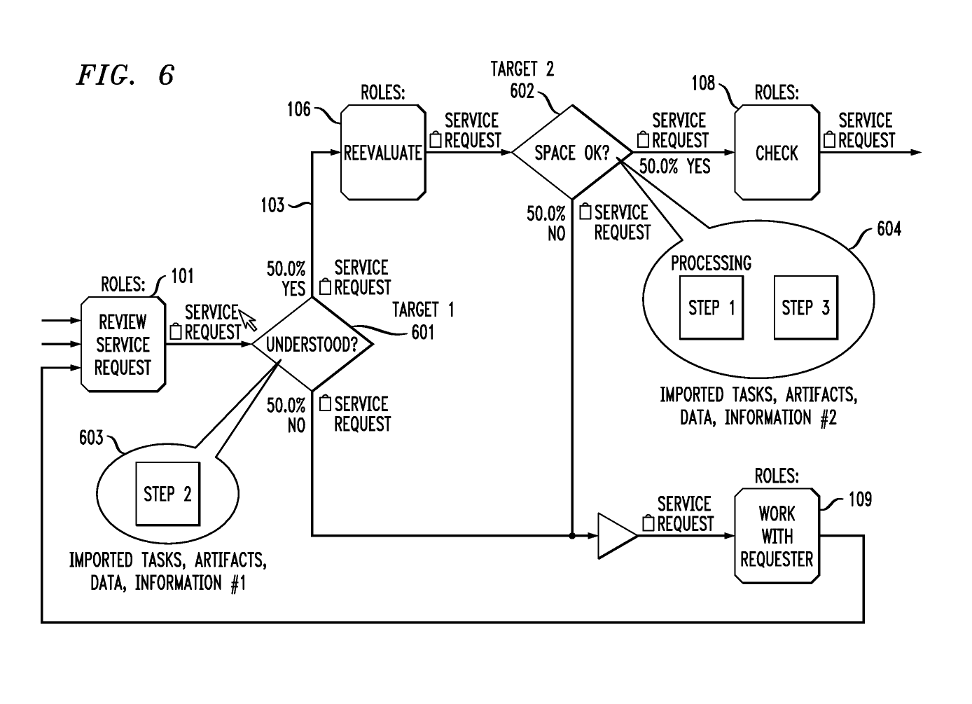

FIG. 6 is a diagram illustrating a target process with input steps from other processes and places within the target process requiring such inputs, according to an embodiment of the present invention. FIG. 6 depicts the introduction of associations, relationships, locks or pre-fetching details to a target process so that dependency and open-ended variations present within a target process can be minimized. As an illustration of associativity, steps 601 and 602 represent decisions where inputs from tasks (present within another process, herein represented as components 603 and 604) are required. Once these tasks are imported into the target process in terms of artifacts, data and information, it would be easier and less expensive for any tasks within a target process to interact and seek details from a different process (which would be more expensive in terms of time and perhaps resources associated with the other tasks to provide for the target process). Additionally, as also illustrated in FIG. 1, component 101 represents process steps, while component 103 represent a relationship and/or association while components 106, 108 and 109 represent task and/or process steps.

FIG. 7 is a diagram illustrating a new target process with pre-fetched, imported data, artifacts and information along with changed associations and dissociations, according to an embodiment of the present invention. FIG. 7 depicts the final process, artifacts (including pre-fetched contents, as data, information), introduced locks, splits or merges so that the target process could be executed more efficiently. Once the process step details are available (as in FIG. 6), the detail associativity and relations are prepared to establish locks, replacement of old associations and/or relationships by way of new data, artifacts and information available as pre-fetched information from a warehouse. Step 701 includes the new input instruction or relationship to the entities already available (for example, at step 2 (that is, component 700). Similarly, step 702 includes the output from pre-fetched entity. Step 706 represents a lock, which would require steps 704 and 705 to be pre-fetched in sequence for the target process. Also, step 703 represents the old associations which need to be removed from the process task. Further, as noted elsewhere, components 101 and 107 represent tasks and/or process steps.

FIG. 8 is a flow diagram illustrating techniques for generating a target process, according to an embodiment of the present invention. Step 802 includes identifying at least one of one or more steps and one or more artifacts within a target process and one or more other processes (such as, for example, other processes similar to the target process that have tasks of same or similar kind). The steps can include, for example, atomic steps and/or decision steps. The steps can also include, for example, process-related dependent steps and/or process-related independent steps. The artifacts can include, for example, a time measure, splits and/or merges. Step 804 includes pre-fetching the at least one of one or more steps and one or more artifacts within a target process and one or more other processes. Step 806 includes associating the at least one of one or more steps and one or more artifacts to be used in the target process at one or more decision points to generate the target process.

The techniques depicted in FIG. 8 can also include cataloging and warehousing the steps and/or artifacts within a target process and one or more other processes, as well as determining one or more decision points in the target process. One or more embodiments of the invention also include representing processes, cost structures and role annotations, wherein the processes, cost structures and role annotations are synchronized at a smallest indivisible task (for example, symbolic representation of a process chain with identifiable characteristics towards defining specific nature of an enterprise process). Additionally, the techniques described herein can also include defining relationships and transaction locks between two or more process steps.

Further, the techniques depicted in FIG. 8 also include, for example, backlogging prevention and dynamic rerouting within a process chain operation to meet one or more needs of a user (for example, a customer). Also, one or more embodiments of the invention include organizing, associating, disassociating, pre-fetching (for example, pre-fetching atomic processes through process organization and cataloguing), introducing and removing locks within IT processes. Additionally, the techniques described herein include insertion of data and information to attach to the process so that the external dependencies towards carrying out decisions could be minimized, as well as cross-utilization of resources within a process chain to improve end-to-end process operation and execution.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

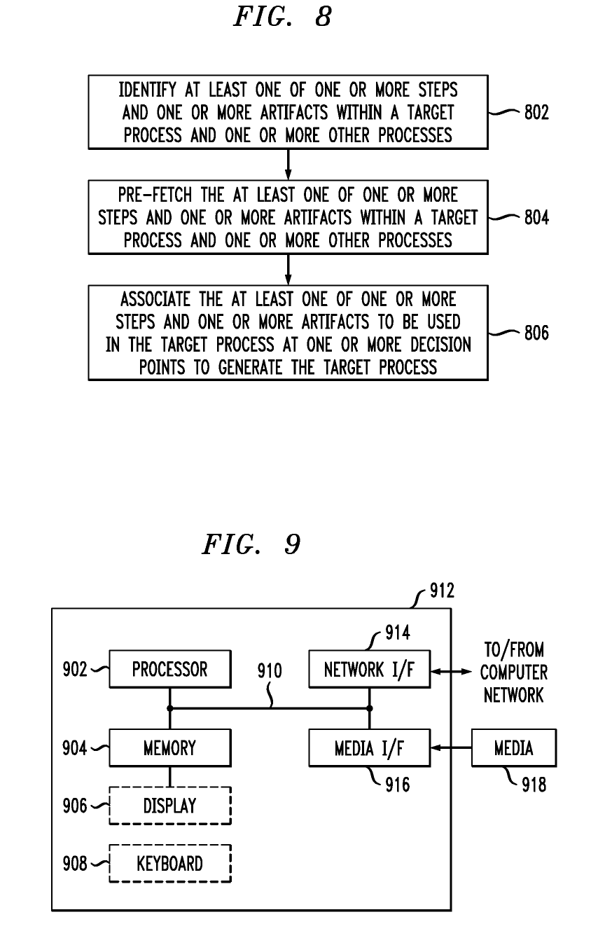

At present, it is believed that the preferred implementation will make substantial use of software running on a general-purpose computer or workstation. With reference to FIG. 9, such an implementation might employ, for example, a processor 902, a memory 904, and an input and/or output interface formed, for example, by a display 906 and a keyboard 908. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 902, memory 904, and input and/or output interface such as display 906 and keyboard 908 can be interconnected, for example, via bus 910 as part of a data processing unit 912. Suitable interconnections, for example via bus 910, can also be provided to a network interface 914, such as a network card, which can be provided to interface with a computer network, and to a media interface 916, such as a diskette or CD-ROM drive, which can be provided to interface with media 918.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 918) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical., electromagnetic, infrared, or semiconductor system (or apparatus or device) or a propagation medium. Examples of a computer-readable medium include a semiconductor or solid-state memory (for example, memory 904), magnetic tape, a removable computer diskette (for example, media 918), a random access memory (RAM), a read-only memory (ROM), a rigid magnetic disk and an optical disk. Current examples of optical disks include compact disk-read only memory (CD-ROM), compact disk-read and/or write (CD-R W) and DVD.

A data processing system suitable for storing and/or executing program code will include at least one processor 902 coupled directly or indirectly to memory elements 904 through a system bus 910. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 908, displays 906, pointing devices, and the like) can be coupled to the system either directly (such as via bus 910) or through intervening I/O controllers (omitted for clarity).

Network adapters such as network interface 914 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, creating a relational warehouse, putting together processes, associated annotations and financial as well as costs, that minimizes deficiencies.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for generating a target process, comprising the steps of:
identifying at least one of one or more steps and one or more artifacts within a target process and one or more other processes;
pre-fetching the at least one of one or more steps and one or more artifacts within a target process and one or more other processes; and
associating the at least one of one or more steps and one or more artifacts to be used in the target process at one or more decision points to generate the target process.

2. The method of claim 1, further comprising cataloging the at least one of one or more steps and one or more artifacts within a target process and one or more other processes.

3. The method of claim 1, further comprising warehousing the at least one of one or more steps and one or more artifacts within a target process and one or more other processes.

4. The method of claim 1, wherein the one or more steps comprise at least one of one or more atomic steps and one or more decision steps.

5. The method of claim 1, wherein the one or more steps comprise at least one of one or more process-related dependent steps and one or more process-related independent steps.

6. The method of claim 1, wherein the one or more artifacts comprise at least one of a time measure, one or more splits and one or more merges.

7. The method of claim 1, further comprising determining one or more decision points in the target process.

8. The method of claim 1, further comprising representing one or more processes, one or more cost structures and one or more role annotations, wherein the one or more processes, one or more cost structures and one or more role annotations are synchronized at a smallest indivisible task.

9. The method of claim l, further comprising defining one or more relationships and one or more transaction locks between two or more process steps.

10. The method of claim 1, further comprising backlogging prevention and dynamic rerouting within a process chain operation to meet one or more needs of a user.

11. The method of claim 10, wherein the user comprises a customer.

12. A computer program product comprising a computer readable medium having computer readable program code for generating a target process, said computer program product including:
computer readable program code for identifying at least one of one or more steps and one or more artifacts within a target process and one or more other processes;
computer readable program code for pre-fetching the at least one of one or more steps and one or more artifacts within a target process and one or more other processes; and
computer readable program code for associating the at least one of one or more steps and one or more artifacts to be used in the target process at one or more decision points to generate the target process.

13. The computer program product of claim 12, wherein the one or more steps comprise at least one of one or more atomic steps and one or more decision steps.

14. The computer program product of claim 12, wherein the one or more steps comprise at least one of one or more process-related dependent steps and one or more process-related independent steps.

15. The computer program product of claim 12, wherein the one or more artifacts comprise at least one of a time measure, one or more splits and one or more merges.

16. The computer program product of claim 12, further comprising computer readable program code for cataloging the at least one of one or more steps and one or more artifacts within a target process and one or more other processes.

17. The computer program product of claim 12, further comprising computer readable program code for warehousing the at least one of one or more steps and one or more artifacts within a target process and one or more other processes.

18. The computer program product of claim 12, further comprising computer readable program code for determining one or more decision points in the target process.

19. The computer program product of claim 12, further comprising computer readable program code for representing one or more processes, one or more cost structures and one or more role annotations, wherein the one or more processes, one or more cost structures and one or more role annotations are synchronized at a smallest indivisible task.

20. The computer program product of claim 12, further comprising computer readable program code for defining one or more relationships and one or more transaction locks between two or more process steps.

21. The computer program product of claim 12, further comprising computer readable program code for backlogging prevention and dynamic rerouting within a process chain operation to meet one or more needs of a user.

22. The computer program product of claim 21, wherein the user comprises a customer.

23. An apparatus for generating a target process, comprising:
a memory; and
at least one processor coupled to said memory and operative to:
identify at least one of one or more steps and one or more artifacts within a target process and one or more other processes;
pre-fetch the at least one of one or more steps and one or more artifacts within a target process and one or more other processes; and
associate the at least one of one or more steps and one or more artifacts to be used in the target process at one or more decision points to generate the target process.

24. The apparatus of claim 23, wherein the one or more steps comprise at least one of one or more atomic steps and one or more decision steps.

25. The apparatus of claim 23, wherein the one or more steps comprise at least one of one or more process-related dependent steps and one or more process-related independent steps.

26. The apparatus of claim 23, wherein the one or more artifacts comprise at least one of a time measure, one or more splits and one or more merges.

27. The apparatus of claim 23, wherein the at least one processor coupled to said memory is further operative to catalogue the at least one of one or more steps and one or more artifacts within a target process and one or more other processes.

28. The apparatus of claim 23, wherein the at least one processor coupled to said memory is further operative to warehouse the at least one of one or more steps and one or more artifacts within a target process and one or more other processes.

29. The apparatus of claim 23, wherein the at least one processor coupled to said memory is further operative to determine one or more decision points in the target process.

30. The apparatus of claim 23, wherein the at least one processor coupled to said memory is further operative to represent one or more processes, one or more cost structures and one or more role annotations, wherein the one or more processes, one or more cost structures and one or more role annotations are synchronized at a smallest indivisible task.

31. The apparatus of claim 23, wherein the at least one processor coupled to said memory is further operative to define one or more relationships and one or more transaction locks between two or more process steps.

32. The apparatus of claim 23, wherein the at least one processor coupled to said memory is further operative to backlog prevention and dynamic rerouting within a process chain operation to meet one or more needs of a user.

33. The apparatus of claim 32, wherein the user comprises a customer.
